(19) United States
(12) Patent Application Publication
(10) Pub. No.: US 2026/0296285 A1
(43) Pub. Date: Oct. 1, 2026

(54) SEAT FOR VEHICLE

(71) Applicants: Hyundai Motor Company, Seoul (KR); Kia Corporation, Seoul (KR); ESP CO.,LTD, Ulsan (KR); SEOYON E-HWA CO., LTD., Anyang-si (KR)

(72) Inventors: Ji Seob PARK, Hwaseong-si (KR); Ji Ah KIM, Hwaseong-si (KR); Ji Yun HA, Hwaseong-si (KR); Jin Ho HWANG, Hwaseong-si (KR); Young Min KIM, Hanam-si (KR); Jae Moon JEONG, Namyangju-si (KR)

(21) Appl. No.: 19/291,161

(22) Filed: Aug. 5, 2025

(30) Foreign Application Priority Data
Mar. 25, 2025 (KR) 10-2025-0038112

(51) Int. Cl. B60N 2/90; B60N 2/58

(52) U.S. Cl. CPC B60N 2/90; B60N 2/58

(57) ABSTRACT

A seat for a vehicle includes a rear partition assembly disposed adjacent to a rear surface of the seat and configured to be selectively deployed, a seat cover that defines a rail portion coupled to the rear partition assembly, a partition driver configured to apply a driving force to the rear partition assembly, and a controller configured to apply power to the partition driver in response to a user request.

### CROSS-REFERENCE TO RELATED APPLICATION

This application claims, under 35 U.S.C. § 119(a), the benefit of and priority to Korean Patent Application No. 10-2025-0038112, filed on Mar. 25, 2025, the entire contents of which are incorporated herein by reference.

### TECHNICAL FIELD

The present disclosure relates to a seat for a vehicle. More particularly, the present disclosure relates to a seat for a vehicle, where the seat includes a rear partition assembly configured to be deployed in a height direction along a rear surface of the seat and capable of interlocking with a side partition assembly.

### BACKGROUND

A vehicle may include a seat configured to seat a passenger thereon. In some cases, the vehicle may include a partition to keep a personal space of the passenger in the vehicle.

For instance, the partition mounted in a vehicle may have a fixed structure, where it is difficult to change the position of the partition according to the user's seating height.

In some cases, a partition may provide a personal space for a passenger in a vehicle, where the partition configuration may separate the personal space rather than simply being deployed along one side surface.

In some cases, a partition structure may be capable of being deployed in response to the positional relations in the seat and capable of blocking a light source entering in a height direction.

### SUMMARY

The present disclosure describes a seat for a vehicle including a rear partition assembly capable of being selectively deployed along a rear surface of the seat.

The present disclosure further describes a partition structure in which the rear partition assembly moves forward and upward in the height direction of the seat occupant in response to the position of the seat.

According to one aspect of the subject matter described in this application, a seat for a vehicle includes a rear partition assembly disposed adjacent to a rear surface of the seat and configured to be selectively deployed, a seat cover that defines a rail portion coupled to the rear partition assembly, a partition driver configured to apply a driving force to the rear partition assembly, and a controller configured to apply power to the partition driver in response to a user request.

Implementations according to this aspect can include one or more of the following features. For example, the rear partition assembly can include a rear partition configured to be deployed from a rear portion of the seat, a partition bracket coupled to the rail portion, a pulley disposed at a rear upper end of the seat, a wire coupled to the pulley and the partition bracket, and a drum coupled to the wire via the partition driver. In some examples, the rear partition can be configured to surround at least a portion of the rear portion and a side of the seat.

In some implementations, the partition bracket can include a first protrusion and a second protrusion that is disposed adjacent to the first protrusion, where the rail portion includes (i) a first rail that receives the first protrusion on the partition bracket and (ii) a second rail that receives the second protrusion on the partition bracket.

In some implementations, the seat can further include a linear bush disposed at the wire, where at least a portion of the linear bush is fixed to the rear partition. In some implementations, the seat can further include a rear guide portion disposed at opposite sides of the seat cover, where the linear bush is coupled to the partition bracket and configured to move together with the rear partition along the rear guide portion.

In some examples, an upper end of the second rail in a height direction of the seat can be located higher than an upper end of the first rail in the height direction. In some examples, an upper end of the rear partition can be configured to deployed in the height direction along the rail portion, and the second protrusion can be configured to, based on the upper end of the rear partition being deployed in the height direction, move along the second rail such that the upper end of the rear partition moves toward a seating surface of the seat.

In some implementations, the seat cover can further define an insertion groove configured to receive the rear partition assembly, where the seat can further include a partition cover portion configured to cover the insertion groove, the partition cover portion being configured to rotate relative to the seat cover to thereby open the insertion groove.

In some implementations, the seat can further include a side partition assembly disposed adjacent to the rear partition assembly, where the rear partition includes a fastening portion configured to couple to the side partition assembly. In some examples, the controller can be configured to deploy the rear partition assembly in response to the user request, where the side partition assembly is configured to insert into the fastening portion based on the rear partition assembly being deployed in response to the user request.

In some implementations, the wire can be configured to rotate between the pulley and the drum.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

### BRIEF DESCRIPTION OF THE DRAWINGS

The above and other features of the present disclosure will now be described in detail with reference to various implementations thereof illustrated in the accompanying drawings which are given herein below by way of illustration only, and thus are not limitative of the present disclosure.

FIG. 1 illustrates an example of a partition assembly and an armrest assembly included in a seat.

FIG. 2 illustrates an example of positional relations in the armrest assembly when the seat is reclined.

FIG. 3 is a configuration diagram including the partition assembly and the armrest assembly.

FIG. 4 is a configuration diagram of the partition assembly.

FIG. 5 is a configuration diagram of the armrest assembly.

FIG. 6 is a configuration diagram of the partition assembly before use.

FIG. 7 illustrates an example of a deployed state of the partition assembly after use.

FIG. 8A and FIG. 8B illustrate an example of a coupling structure between a main link and an armrest link in a state where a pin of a position restrainer is deployed.

FIGS. 9A and 9B illustrate an example of the coupling structure between the main link and the armrest link in a state where the pin of the position restrainer is released.

FIG. 10 illustrates an example of a seat cover in a state where a rear partition assembly is deployed.

FIG. 11 is a side cross-sectional view of the coupled structure of the rear partition assembly.

FIG. 12 is a front view of the coupled structure of the rear partition assembly.

FIGS. 13 and 14 illustrate the closed state and the opened state of an example of a partition cover portion, respectively.

FIG. 15 illustrates the coupled structure of a side partition assembly and the rear partition assembly when deployed.

FIG. 16A is a configuration diagram showing an example of a matching portion cover positioned at an upper end of the seat cover. and

FIG. 16B is a configuration diagram in which the matching portion cover is stowed in the seat cover.

In the figures, the reference numerals refer to the same or equivalent parts of the present disclosure throughout the several figures of the drawing.

### DETAILED DESCRIPTION

Hereinafter, one or more implementations of the present disclosure are described in detail with reference to the accompanying drawings. The implementations of the present disclosure can be modified into various forms, and the scope of the present disclosure should not be construed as being limited to the following implementations.

Terms such as “ . . . portion,” “ . . . unit,” “ . . . module,” etc. used in the present specification each refer to a unit that processes at least one function or operation, and can be implemented as hardware, software or a combination thereof.

In some implementations, a controller 500 can be implemented as a memory that stores algorithms for controlling operation of various components placed in a vehicle or data on a program that reproduces algorithms and a processor that performs the above described operation using data stored in the memory. Here, the memory and the processor can be implemented as separate chips. Alternatively, the memory and the processor can be implemented as a single chip. For example, the controller 500 can include at least two selected from an electronic controller (ECU), a central processing unit (CPU), a microprocessor unit (MPU), a micro controller unit (MCU), an application processor (AP) or any form of processor well known in the art to which the present disclosure pertains. Moreover, the controller 500 can be a combination of software and hardware capable of performing calculations for at least one application or program to execute a method according to the implementations of the present disclosure.

Hereinafter, one or more implementations are described in detail with reference to the accompanying drawings, and in the description provided with reference to the accompanying drawings, the same or corresponding components are assigned the same reference numerals, and a description thereof is not repeated.

The present disclosure relates to a seat for a vehicle (“vehicle seat”) 10. More particularly, the present disclosure relates to a partition assembly 100 placed adjacent to the vehicle seat 10 and an armrest assembly 200 capable of being driven integrally with the partition assembly 100. A side partition assembly can refer to the partition assembly 100.

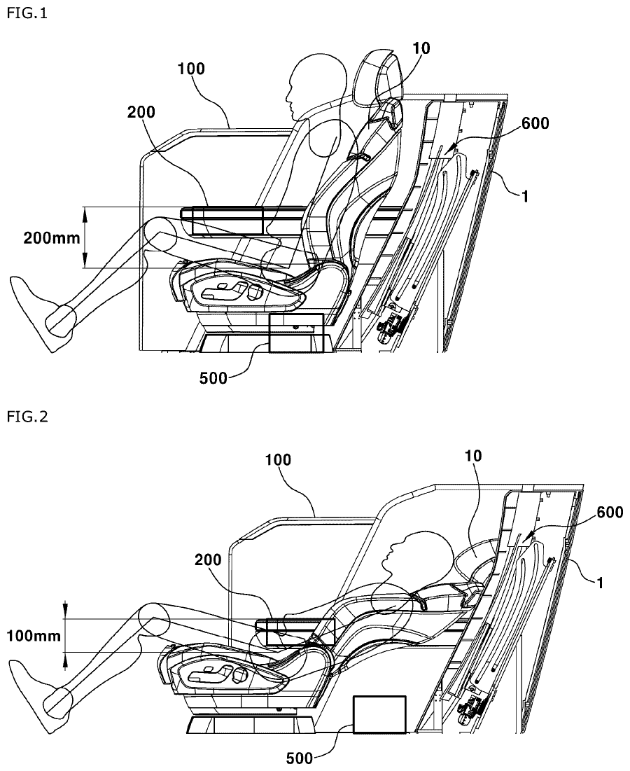

FIG. 1 illustrates the configuration of the vehicle seat 10, the partition assembly 100, and the armrest assembly 200.

In some implementations, the vehicle seat 10 includes at least one or more partition assemblies 100 configured to partition the seat 10. Moreover, the partition assembly 100 includes the armrest assembly 200 movable upward and downward in the height direction of the vehicle and forward and rearward in the length direction of the vehicle.

The partition assembly 100 includes a partition portion 120 placed in a frame 110, and includes a partition link unit 130 fastened to the partition portion 120 so that the driving force of the drive portion 300 is applied to the partition portion 120. When the driving force of the drive portion 300 is applied, the partition portion 120 is deployed upward and downward in the height direction of the vehicle and forward and rearward in the length direction of the vehicle, through the partition link unit 130.

In some examples, the armrest assembly 200 is placed to be selectively movable along the partition portion 120. Because the armrest assembly 200 includes an armrest portion 210 on which a user's arm can be rested, when the rotational force of the drive portion 300 is applied, the armrest portion 210 can be moved forward in the length direction of the vehicle and downward in the height direction of the vehicle.

In some implementations, the controller 500 can be a vehicle controller 500, and can be a concept including an electronic controller (ECU) or a controller 500 for the seat 10. The controller 500 can operate the partition assembly 100 and/or the armrest assembly 200 when a user request is applied. More specifically, in response to receiving a request to perform seat reclining or a request to deploy the partition portion 120 as a user request, the controller 500 can control the vehicle's battery to supply power to the drive portion 300.

For instance, the seat reclining refers to an operation where a seatback is deployed rearwards at a predetermined angle or more, and the front end of a seat cushion is raised correspondingly so that the seat cushion has a predetermined angle.

In some examples, because the controller 500 is capable of controlling a pin of a position restrainer 270, the controller 500 can set the movement of the armrest assembly 200 selectively or integrally with the partition portion 120.

FIG. 2 illustrates the change of the armrest portion 210 in height and length direction in the reclined state of the seat 10.

The controller 500 that has received the user input or request can perform reclining of the seat 10 and can change the position of the armrest assembly 200 in the height and length direction in response to the change in the angle of the seat 10 due to the reclining of the seat 10.

In some implementations, the armrest assembly 200 can be moved integrally with the partition assembly 100. Furthermore, the controller 500 can be configured to control the position restrainer 270, allowing only the partition assembly 100 to be independently deployed forward in the length direction of the vehicle and upward in the height direction of the vehicle.

More specifically, the drive portion 300 in the present disclosure is configured to move the partition portion 120 forward in the length direction of the vehicle using a first transfer link 141 fastened to the partition portion 120, wherein the partition link unit 130 includes a main link 131, the first transfer link 141, and a second transfer link 142, and configured to move the partition portion 120 upward in the height direction of the vehicle using the second transfer link 142. At the same time, the drive portion 300 is configured to move the armrest portion 210 forward in the length direction of the vehicle and downward in the height direction of the vehicle using an armrest link 220 fastened to the main link 131.

For instance, the height difference between the seating surface and the armrest portion 210 can be 200 mm when the seat 10 is in the upright position as illustrated in FIG. 1, and the height difference between the seating surface and the armrest portion 210 can be 110 mm when the seat 10 is in the reclined position as illustrated in FIG. 2. As such, the accessibility to the armrest portion 210 of the user seated on the seat 10 can be improved when the seat 10 is switched to be reclined.

Moreover, the position restrainer 270 allows the main link 131 and the armrest assembly 200 to be selectively fastened to each other, allowing the partition assembly 100 and the armrest assembly 200 to be selectively operated. More specifically, in response to a user's input or setting, the controller can select only the deployment of the partition assembly 100 or can select driving of both the partition assembly 100 and the armrest assembly 200.

In some implementations, the drive portion 300 can apply a driving force to the partition assembly 100 or can apply a driving force to both the partition assembly 100 and the armrest assembly 200.

In some implementations, when the controller receives a seat reclining request, the controller can apply a driving force to both the partition assembly 100 and the armrest assembly 200 through driving of the drive portion.

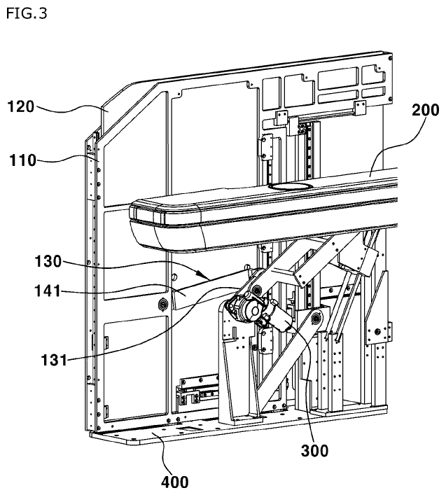

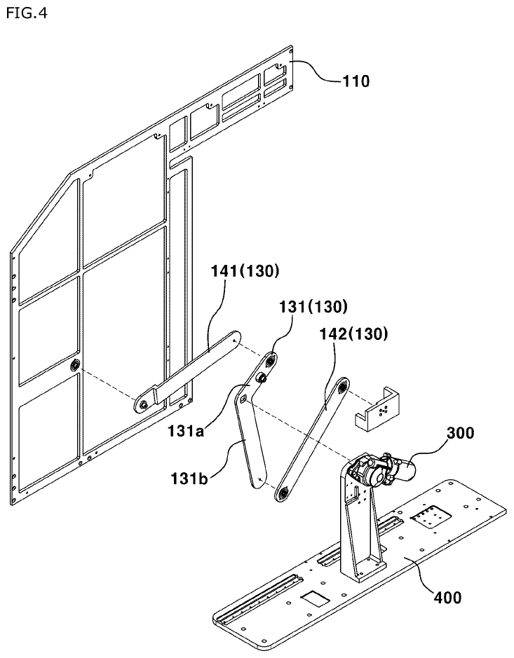

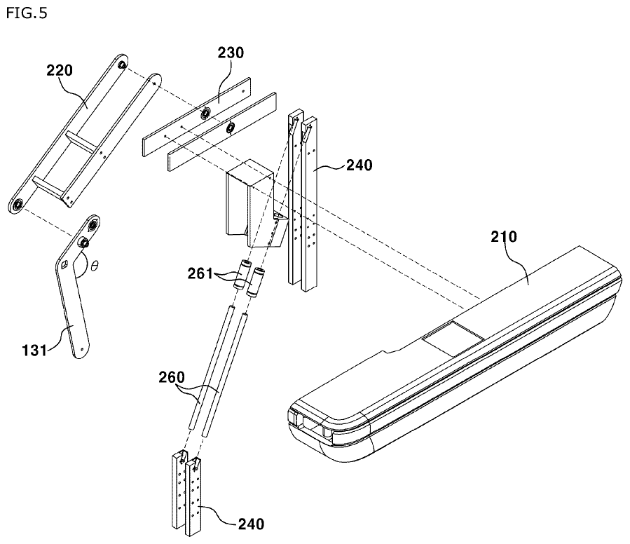

In some implementations, FIG. 3 is a configuration diagram of the partition assembly 100 and the armrest assembly 200 of the vehicle seat 10, FIG. 4 is a configuration diagram of the partition assembly 100, and FIG. 5 is a configuration diagram of the armrest assembly 200.

The partition assembly 100 is placed on at least one side surface of the vehicle seat 10, and the armrest assembly 200 is placed on one side surface of the partition assembly 100 facing the seat 10. The partition assembly 100 includes the frame 110 placed vertically from the floor of the vehicle, and the partition portion 120 placed inside the frame 110 and configured to move in response to the driving force of the drive portion 300.

The main link 131 is fastened to the rotation shaft of the drive portion 300, and the first transfer link 141 is connected to one end of the main link 131. The first transfer link 141 is fastened adjacent to the front end of the partition portion 120. In the state before the operation of the drive portion 300, another end of the main link 131 is fastened to the second transfer link 142 in an area adjacent to the lower end of the partition portion 120.

The main link 131 includes a first sub-link 131a fastened to the first transfer link 141 and a second sub-link 131b fastened to the second transfer link 142, wherein the rotation axis of the main link 131 centered on is connected to the drive portion 300. The first sub-link 131a is shorter than the second sub-link 131b, and the first sub-link 131a and the second sub-link 131b have a predetermined angle with respect to the rotation axis of the main link 131.

Therefore, when the main link 131 is rotated by the drive portion 300, the amount of movement by which the partition portion 120 moves forward in the length direction of the vehicle through the first transfer link 141 as the first sub-link 131a rotates is smaller than the amount of movement by which the partition portion 120 moves in the height direction through the second transfer link 142 as the second sub-link 131b rotates.

Here, the lengths of the first sub-link 131a and the second sub-link 131b, and the angle formed between the first sub-link 131a and the second sub-link 131b can vary depending on the length-wise movement amount and height-wise movement amount of the partition portion 120.

In some implementations, the drive portion 300 is fixed on a base 400 by being fastened to a bracket, and the main link 131 placed on the rotation shaft of the fixed drive portion 300 has opposite ends fastened to the first transfer link 141 and the second transfer link 142, respectively. Furthermore, the one end of the main link 131 fastened to the first transfer link 141 is fastened to the armrest link 220. The armrest link 220 has another end fastened to an armrest hinge link 230 placed in the armrest portion 210. Therefore, when the armrest hinge link 230 moves together with the armrest link 220, the armrest portion 210 moves along the armrest hinge link 230.

Moreover, the armrest link 220 is placed on the first sub-link 131a and has a similar movement path to the first transfer link 141 when the main link 131 rotates. Therefore, the armrest portion 210 has a movement amount similar to the length-wise movement amount of the partition portion 120.

Furthermore, the armrest hinge link 230 is, integrally with an armrest block 250, fastened to the armrest portion 210. The armrest block 250 surrounds a guide portion 260 protruding from the lower end of the armrest portion 210 and penetrating the armrest block 250. Furthermore, a bush portion 261 is placed in the armrest block 250, wherein the bush portion 261 is placed in a form of wrapping around the guide portion 260.

Moreover, the guide portion 260 has opposite ends fixed to an armrest frame 240 that is fastened to the base 400. In some implementations, the armrest frame 240 is fixed to the base 400 at the front and rear ends of the armrest block 250, and the guide portion 260 is inclined to be fastened to the armrest frame 240.

In the present disclosure, when the driving force of the drive portion 300 is applied to the armrest portion 210, the armrest link 220 fastened to the main link 131 moves integrally with the armrest hinge link 230, and the armrest portion 210 fastened to the armrest hinge link 230 moves in the same direction as the movement direction of the armrest hinge link 230. Furthermore, the armrest block 250 placed at the rear end of the armrest portion 210 moves integrally with the armrest portion 210 in the inclined direction of the guide portion 260. Therefore, when the driving force of the drive portion 300 is applied to the armrest portion 210, the armrest portion 210 moves forward in the length direction of the vehicle and downward in the height direction of the vehicle while maintaining the state of being parallel to the length direction of the vehicle.

As such, the armrest portion 210 fastened to the armrest link 220 moves forward and downward in the rotational direction of the main link 131, and the rear end of the armrest portion 210 includes the armrest block 250 fastened to the guide portion 260, allowing the armrest portion 210 to maintain the state of being parallel to the length direction of the vehicle.

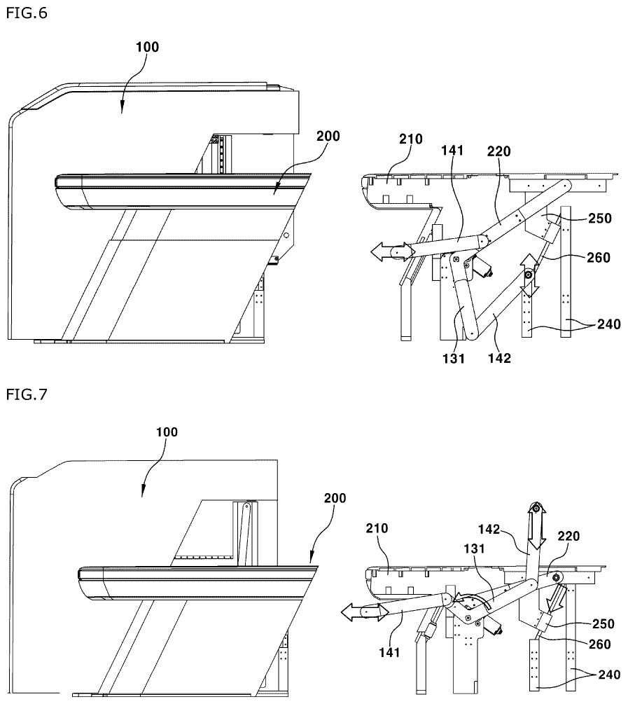

FIG. 6 illustrates a state before the partition assembly 100 and the armrest assembly 200 are deployed.

As illustrated in the drawing, the main link 131 fastened to the rotation shaft of the drive portion 300 has the one end placed higher in the height direction and the other end placed lower in the height direction. Furthermore, the armrest link 220 is fastened to the main link 131 at a position adjacent to the one end of the main link 131.

With the first transfer link 141 being fastened to the partition portion 120 and to the one end of the main link 131, the partition portion 120 is placed inside the frame 110 in a state in which the main link 131 is not rotated. Moreover, with the second transfer link 142 being fastened to the other end of the main link 131 adjacent to the base 400, the partition portion 120 is placed inside the frame 110 in the height direction.

FIG. 7 illustrates the positions of the partition portion 120 and the armrest portion 210 in a state in which a current is applied to the drive portion 300.

As illustrated in the drawing, when power is applied to the drive portion 300 and the rotation shaft of the drive portion 300 is rotated counterclockwise in the drawing, the main link 131 fastened to the rotation shaft of the drive portion 300 rotates in the same direction as the drive portion 300. Accordingly, the one end of the main link 131 rotates from the right side to the left side of the drive portion 300, and the first transfer link 141 fastened to the one end of the main link 131 can apply tension to the frame 110 so that the frame 110 moves in the length direction. In some implementations, the height of the one end of the main link 131 fastened to the first transfer link 141 is kept constant before and after the driving of the drive portion 300, and thus the length-wise movement amount of the first transfer link 141 is substantially the same as the length-wise movement amount of the partition portion 120.

At the same time, the other end of the main link 131 is, in response to the rotation of the drive portion 300, moved upward in the height direction from a state located at the bottom with respect to the base 400, as illustrated in FIG. 6. Furthermore, because the second transfer link 142 fastened to the other end of the main link 131 is moved integrally with the partition portion 120, the partition portion 120 can be moved in the height direction in response to the height direction movement of the other end of the main link 131.

Here, in response to the other end of the main link 131 moving in the height direction, the other end of the main link 131 is configured to have the same length-wise position before and after the driving of the drive portion 300, and thus the height-wise movement amount of the other end of the main link 131 is configured to be substantially the same as the length-wise movement amount of the partition portion 120.

Moreover, the armrest link 220 is fastened to the main link 131 at a position adjacent to the one end of the main link 131 to which the first transfer link 141 is fastened, and is configured to move the armrest portion 210 in the length direction in response to the amount of rotation of the main link 131. Furthermore, because the armrest link 220 is moved to have a predetermined inclination in response to the rotation of the main link 131, the armrest portion 210 is moved forward and downward in response to the movement direction of the armrest link 220. In other words, the length-wise movement amount of the armrest link 220 is smaller than the movement amount of the partition portion 120, and the armrest link 220 is switched to be moved downward in the height direction.

In some examples, because the length-wise movement amount of the armrest portion 210 is determined differently depending on the fastened position between the armrest link 220 and the main link 131, the length-wise and height-wise movement amounts between the partition portion 120 and the armrest portion 210 can vary.

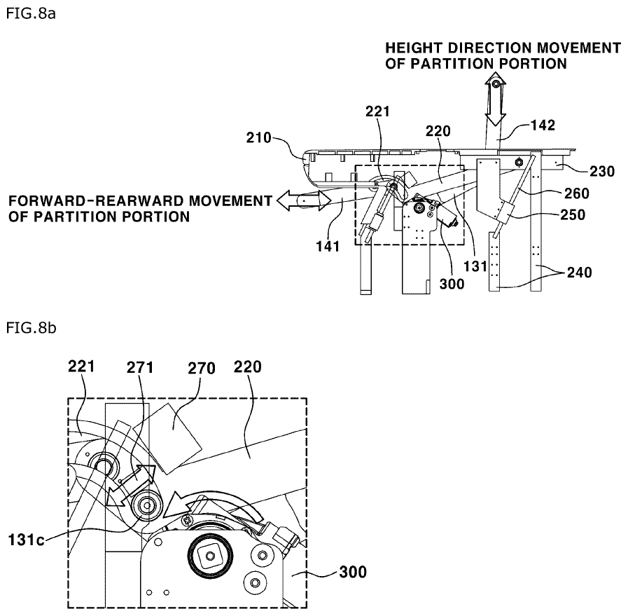

FIGS. 8A and 8B illustrate, for example, driving relations in a vehicle seat 10 including a position restrainer 270, and a state in which a pin 271 of the position restrainer 270 is fastened inside a slot 221 in an armrest link 220.

As illustrated in the drawing, in some implementations, the armrest link 220 is placed adjacent to a main link 131, and a protrusion 131c of the main link 131 is placed inside the slot 221 in the armrest link 220. Furthermore, the position restrainer 270 is placed at an external side of the armrest link 220 and the pin 271 is selectively inserted into the slot 221. The position restrainer 270 includes the pin 271 that is selectively inserted into the slot 221. More specifically, the pin 271 of the position restrainer 270 is mutually restrained with the protrusion 131c of the main link 131, allowing the armrest link 220 and the main link 131 to move integrally with each other.

As illustrated in FIG. 8B, the protrusion 131c of the main link 131 is placed at one end of the slot 221 adjacent to the position restrainer 270, and the pin 271 of the position restrainer 270 is inserted into the slot 221. Here, the protrusion 131c of the main link 131 is rotatably placed inside the slot 221, and thus, when the main link 131 rotates, the protrusion 131c, integrally with the main link 131, applies a rotational force to the armrest link 220. More specifically, based on the main link 131 and the armrest link 220 being fastened to each other through the protrusion 131c, the armrest assembly 200 moves integrally with the partition assembly 100 when the partition assembly 100 is deployed.

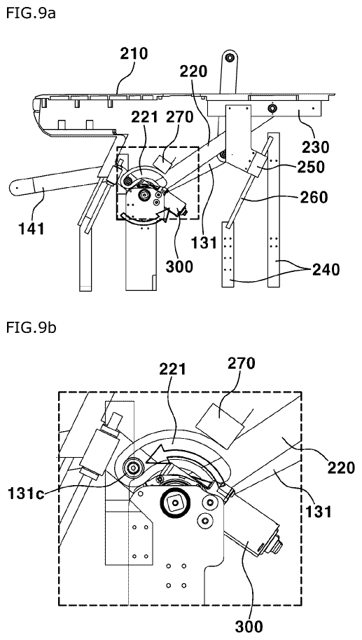

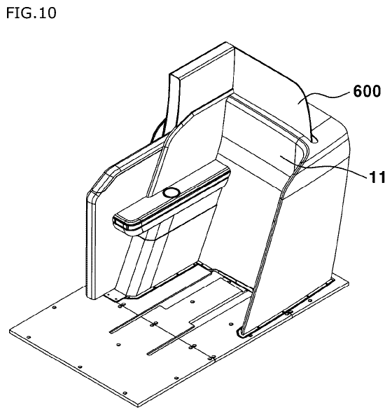

FIGS. 9A and 9B illustrate an example state in which the pin 271 of the position restrainer 270 is separated from the slot 221. For example, when the partition assembly 100 is deployed in the length direction and height direction, the driving force of the drive portion 300 is not applied to the armrest assembly 200. More specifically, when the main link 131 is rotated, the protrusion 131c placed at the one end of the slot 221 can be moved to another end of the slot 221 without the armrest link 220 being moved.

In other words, the protrusion 131c can move along the inside of the slot 221 without the driving force of the drive portion 300 being applied to the armrest link 220. Because the shape of the slot 221 corresponds to the movement path of the protrusion 131c, the driving force of the drive portion 300 is not applied to the armrest link 220. Accordingly, the partition portion 120 is deployed in the length direction and the height direction of the vehicle, and the armrest portion 210 maintains the position same as the position before being operated.

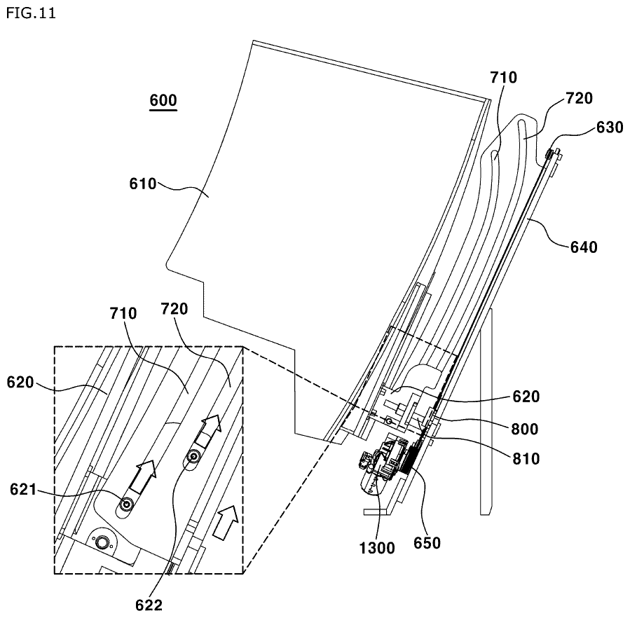

FIG. 10 is a perspective view of the vehicle seat according to the present disclosure, illustrating a state where a rear partition assembly 600 is deployed, and FIG. 11 is a cross-sectional view of the configuration of the rear partition assembly 600.

The vehicle seat of the present disclosure includes the rear partition assembly 600 that is inserted into the inside of the seat cover 11 of the seat and then is selectively deployed, which is performed separately from the partition assembly 100 illustrated in FIGS. 1 to 9. The rear partition assembly 600 can be deployed along the rear surface of the vehicle, and more specifically, at least a portion of the rear partition assembly 600 can be placed on a side where the partition assembly is placed.

The rear partition assembly 600 has a structure in which the rear partition assembly 600 is deployed in the height direction of the vehicle and then the upper end of a rear partition 610 is rotated in a direction toward the seating surface at a predetermined height. In other words, because the rear partition 610 is deployed while surrounding not only the rear of the seat occupant but also a part of the upper portion, the seat can be converted to have a shape of being blocked from the outside.

As illustrated in FIG. 11, the rear partition assembly 600 is placed between the rear of the seat and the cover 11, and the rear partition 610 can be moved upward along a rail portion 700 placed on opposite sides of the cover 11.

Specifically, the rear partition assembly 600 includes the rear partition 610 configured to be deployed along the cover 11, a partition bracket 620 placed between the rear partition 610 and the rail portion 700, a linear bush 800 configured to fasten the partition bracket 620 and a wire 640 to each other, the wire 640 on which the linear bush 800 is placed, and a partition driver 1300 fastened to a drum 650 configured to transfer a driving force to the wire 640.

The partition bracket 620 extending from the rear partition 610 to be inserted into the inside of the rail portion 700 is placed along the width of the rear partition 610. Furthermore, the partition bracket 620 is placed between the rear of the seat and the cover 11 and is fastened to the rail portion 700.

In some implementations, the partition bracket 620 includes a first protrusion 621 fastened to a first rail 710 and a second protrusion 622 fastened to a second rail 720. Here, the first rail 710 is placed adjacent to the rear partition 610, and the second rail 720 is placed between the first rail 710 and the cover 11.

Moreover, the highest point (i.e. an upper end) of the second rail 720 is higher in the height direction than the highest point of the first rail 710. Therefore, when the first protrusion 621 and the second protrusion 622 are integrally moved along the first rail 710 and the second rail 720 by the driving force of the partition driver 1300 and the first protrusion 621 comes into contact with the highest point of the first rail 710, the second protrusion 622 is further moved along the second rail 720. In other words, in response to the partition bracket 620 moving along the first rail 710 and the second rail 720 simultaneously, the rear partition 610 is deployed in the same inclination as the seat cover 11. Afterwards, as the first protrusion 621 comes into contact with the highest point of the first rail 710 and the second protrusion 622 is further moved along the second rail 720, the rear partition 610 rotates about the first protrusion 621. In some implementations, when the partition bracket 620 is rotated about the first protrusion 621, the upper end of the rear partition 610, configured to be deployed along the seat cover 11, moves toward the upper surface of the seating surface of the seat.

In some implementations, the first rail 710 and the second rail 720 can include rail grooves each having the same height, and as the first rail 710 and the second rail 720 move upward along the seat cover 11, the first rail 710 and the second rail 720 can have a curvature in a direction in which the upper ends of the first rail 710 and the second rail 720 lean toward the seating surface of the seat. Accordingly, as the first protrusion 621 and the second protrusion 622 move along the seat cover 11, the upper end of the rear partition 610 gradually moves in a direction toward the front end of the seat.

The partition driver 1300 is located at the inner lower end of the seat cover 11 and includes the drum 650 fastened to a drive shaft of the partition driver 1300. The partition driver 1300 can apply a driving force to the drum 650 and apply a tension to the wire 640 configured to rotate along the drum 650. The wire 640 in the present disclosure is connected to the partition bracket 620 through the drum 650. Furthermore, the wire 640 fastened to the drum 650 is placed to be fixed to the partition bracket 620 via a pulley 630 that is located at the inner upper end of the cover 11. Accordingly, when the rotational force of the partition driver 1300 is applied to the wire 640 in one direction of the drum 650, a height-direction tension is applied to the partition bracket 620, and when the rotational force of the partition driver 1300 is applied to the wire 640 in another direction of the drum 650, the deployed rear partition 610 is drawn into the inside of the seat cover 11.

The wire 640 can be implemented as an infinite loop between the pulley 630 and the drum 650, or the wire 640 can be wound and unwound along the inside of the drum. In other words, the wire can include any components configured to transfer a driving force and capable of moving the partition bracket 620 in the height direction of the cover 11. In some examples, the wire 640 is a concept that includes all components capable of being integrally moved as the distance between the cover 11 and the partition bracket 620 changes.

Moreover, the rear partition assembly 600 includes the linear bush 800 fastened to the partition bracket 620. The linear bush 800 can guide the movement of the partition bracket 620 by being fastened to a rear guide portion 900 placed inside the cover 11. Furthermore, the linear bush 800 can control the speed of the rear partition 610 being pulled into the seat cover 11 by the partition driver 1300 or the weight of the rear partition assembly 600. In some implementations, the rear guide portion 900 is provided in two pieces having a predetermined gap between the two pieces in the cover 11, and two linear bushes 800 fastened to the partition bracket 620 are each configured to move along a corresponding one of the rear guide portions 900. Here, the rear guide portion 900 can be a linear motion (LM) guide.

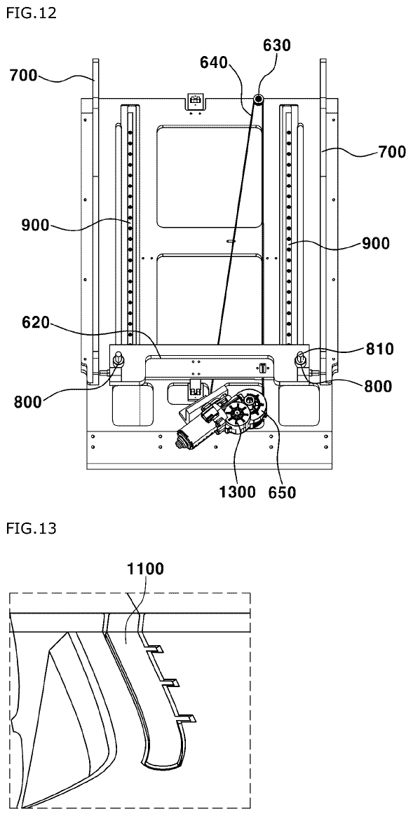

FIG. 12 illustrates the configuration of the wire 640 and the partition bracket 620 to which the wire 640 is fastened.

The wire 640 is placed between the drum 650 and the partition bracket 620 with respect to the pulley 630 located inside the seat cover 11. The pulley 630 is placed on an internal surface of the cover 11 at a position corresponding to the partition bracket 620 when the rear bracket is fully deployed. Furthermore, the controller can control the amount of rotation of the partition driver 1300 to control the tension applied to the partition bracket 620 through the wire 640. In some examples, the partition driver 1300 can be a motor including a rotation shaft fastened inside the drum 650, and the wire 640 is wound around the rotation shaft by one end of the wire 640 being fixed to the rotation shaft inside the drum 650. In some examples, the wire 640 can be implemented as an infinite loop between the pulley 630 and the drum 650, and the drum 650 can be rotated by the partition driver 1300 to transfer the driving force to the partition bracket 620.

Therefore, in response to the rear partition 610 deployment request received by the controller, the partition driver 1300 can apply a rotational force to the wire 640, and an upward driving force is applied to the partition bracket 620 fastened to the wire 640.

The partition bracket 620 to which the driving force is applied is moved to an upper surface of the cover 11 by following the shape of the rail portion 700. Here, the partition bracket 620 can move along the internal surface of the cover 11 in the height direction while maintaining a horizontal state owing to the linear bush 800 fastened to the partition bracket 620 and the rear guide portion 900 fastened to the linear bush 800.

In some implementations, the rail portion 700 has a curvature in the height direction of the cover 11, where the distance between the cover 11 and the partition bracket 620 varies depending on the height of the partition bracket 620 fastened to the rail portion 700. Therefore, in response to the change in the distance in the front-rear direction of the partition bracket 620 fastened to the wire 640, the wire 640 can be kept being connected to the partition bracket 620 with the loop of the wire 640 being constrained to the pulley 630 located at the internal upper end of the cover 11.

Moreover, the partition bracket 620 includes a rod 810 fastened to the linear bush 800, and the linear bush 800 can move along the rod 810 in response to the change in the distance between the partition bracket 620 and the internal surface of the cover 11.

In some implementations, when the rear partition 610 moves along the rail portion 700, the distance between the partition bracket 620 and the internal surface of the cover 11 changes in response to the shape of the rail portion 700, and accordingly, the driving force is applied to the partition bracket 620 through the wire 640. At the same time, the linear bush 800 can absorb the change in distance between the partition bracket 620 and the internal surface of the cover 11 when the partition bracket 620 moves in the height direction.

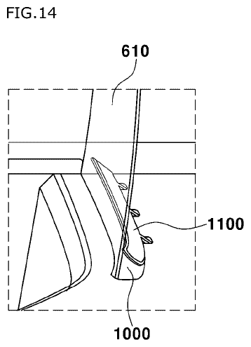

FIGS. 13 and 14 illustrate the configuration of a partition cover portion 1100 placed on an upper surface of the cover 11 and configured to surround an insertion groove 1000 in the cover 11 when the rear partition assembly 600 is deployed.

As illustrated in FIG. 13, when the rear partition 610 is inserted into the inside of the cover 11, the partition cover portion 1100 can be always kept being closed by the tension of a torsion spring located at a hinge point. Here, in response to the driving force of the partition driver 1300 being applied to the drum 650 and the wire 640 applying tension to the partition bracket 620, the rear partition 610 moves in the height direction by being brought into contact with the inner surface of the partition cover portion 1100.

As illustrated in FIG. 14, in response to the driving force of the partition driver 1300 being applied to the inner surface of the partition cover portion 1100, the partition cover portion 1100 can be rotated to be opened with respect to the hinge point of the cover and the rear partition 610 can be deployed.

In other words, before the rear partition 610 is deployed, the insertion groove 1000 in which the rear partition 610 is stowed is closed by the partition cover portion 1100 located at the upper end of the cover, and the partition cover portion 1100 is opened by the driving force applied when the rear partition 610 is deployed.

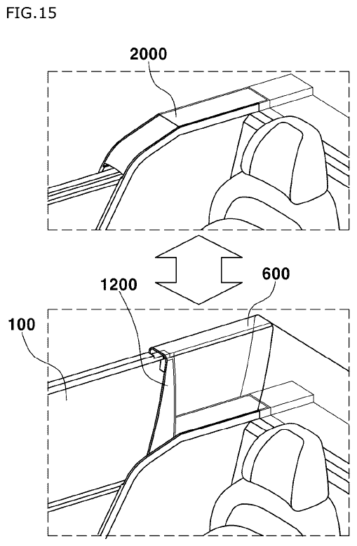

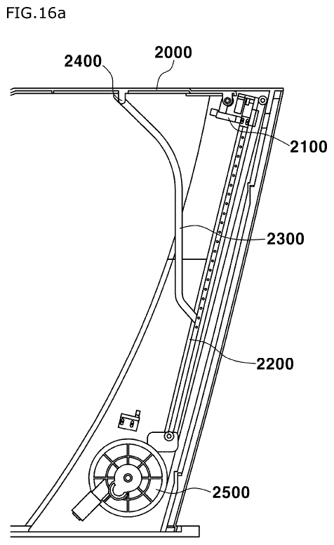

FIG. 15 illustrates the rear partition assembly 600 and a matching portion cover 2000 that are interlocked with the partition assembly configured to be deployed upward along the side surface of the seat.

The rear partition 610 in the present disclosure can be deployed along the rear surface of the seat cover 11 and can include at least a portion of the side surface of the seat cover 11. Furthermore, the rear partition 610 includes a fastening portion 1200 located inside the rear partition 610 so as not to interfere with the deployment of the partition portion located on the side.

The fastening portion 1200 is placed at one end of the rear partition 610 facing the partition portion 120, and at least a portion of the partition portion 120 can be inserted into the rear partition 610. More specifically, in the state of the partition portion 120 and the rear partition 610 being deployed, the partition portion 120 and the rear partition 610 each can have the same height.

As illustrated in the drawing, the matching portion cover 2000 is placed on the side surface. The matching portion cover 2000 is configured to be inserted into the seat cover 11 when the rear partition 610 is deployed upwards. As illustrated in FIG. 15, the matching portion cover 2000 is placed on the side where the rear partition 610 is deployed, and is configured to be inserted into the seat cover 11 when the rear partition 610 is deployed. More specifically, the matching portion cover 2000 is configured to cover the open upper surface of the seat cover 11 in an area adjacent to the fastening portion 1200 where the rear partition 610 and the partition portion 120 face each other.

A motor 2500 is located at a lower inner end of the seat cover 11 where the partition portion 120 is located. The motor 2500 transmits the driving force to the matching portion cover 2000 in the height direction of the seat cover 11. Furthermore, when the rear partition 610 is deployed, the motor 2500 is simultaneously driven so that the matching portion cover 2000 is inserted into the inside of the seat cover 11. Therefore, when the rear partition 610 is deployed, the upper opening in the seat cover 11 is simultaneously opened through the matching portion cover 2000. Furthermore, when the rear partition 610 is deployed, the partition cover portion 1100 and the matching portion cover 2000 can be opened simultaneously or sequentially.

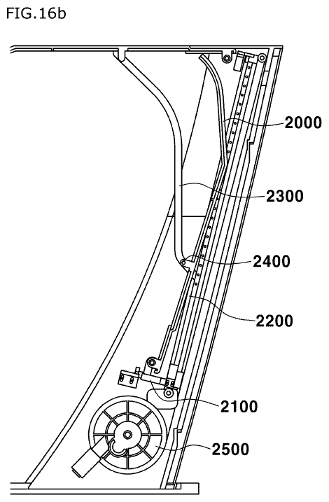

FIG. 16A illustrates the internal configuration of the seat cover 11 before the rear partition 610 is deployed, i.e., the state in which the matching portion cover 2000 is closed, and FIG. 16B illustrates the state in which the matching portion cover 2000 is inserted into the seat cover 11 when the rear partition 610 is deployed.

The internal surface of the seat cover 11 includes an LM guide 2200 on which a block module 2100 fastened to an end of the matching portion cover 2000 is moved, and the matching portion cover 2000 includes, at the center of the matching portion cover 2000, a guide hinge 2400 inserted into a guide groove 2300 and configured to set a height-direction movement path of the matching portion cover 2000 while moving along the guide groove 2300.

The motor 2500 applies a driving force to the block module 2100 and the height of the lower end of the matching portion cover 2000 is regulated along the LM guide 2200. As the matching portion cover 2000 moves in the height direction with the guide hinge 2400 moving along the guide groove 2300, the upper end of the matching portion cover 2000 is moved to face the front of the seat cover 11. Furthermore, the block module 2100 can be hinged to the matching portion cover 2000 to allow the matching portion cover 2000 to rotate about the block module 2100 in the forward and rearward direction.

In other words, as illustrated in FIG. 16A, when the matching portion cover 2000 is placed on the upper opening of the seat cover 11, the matching portion cover 2000 is configured to cover the open area at the upper end of the seat cover 11 by turning in the front-rear direction of the seat cover 11. Furthermore, when the matching portion cover 2000 is placed to cover the open upper end of the seat cover 11, the rear partition 610 is placed inside the seat cover 11.

In some examples, as illustrated in FIG. 16B, the matching portion cover 2000 can be placed inside the seat cover 11 in substantially the same direction as the LM guide 2200 in the seat cover 11. Furthermore, when the matching portion cover 2000 is placed inside the seat cover 11, the rear partition 610 is kept being deployed over the upper end of the seat cover 11.

Here, the motor 2500, LM guide 2200, and guide groove 2300 that perform the driving of the matching portion cover 2000 can be located at opposite sides of the rear partition assembly 600, and furthermore, can be placed inside the seat cover 11 so as not to interfere with the driving of the rear partition.

In some implementations, the rear partition 610 and the fastening portion 1200 can be controlled by the controller to be deployed prior to the side partition portion being deployed. Because at least a portion of the side partition portion can be inserted into the fastening portion 1200 when the rear partition 610 is fully deployed, the partition portion can have a shape to surround at least two sides centered on the seating surface of the seat. For example, the fastening portion 1200 can include a protrusion that protrudes from inner sides of the rear partition 610 and a space that is tapered or narrowed between the inner sides. That is, the fastening portion 1200 can define a fastening space between the inner sides of the rear partition, and the fastening space narrows as the rear partition extends forward.

As is apparent from the above description, the present disclosure can have the following effects by the above-described elements, and combination and use relations thereof.

The present disclosure provides a seat including a rear partition assembly corresponding to the position of the user's seat, providing a comfortable independent space.

Moreover, the present disclosure provides a seat capable of protecting the user's eye through a rear partition assembly that deploys upwards at the rear of the seat.

Furthermore, the present disclosure provides a rear partition assembly that is interlocked with a partition assembly deployed along the side surface, providing stability along the edge of the seat.

The detailed description is merely illustrative of the present disclosure. In addition, the above description shows and describes various aspects of the present disclosure, but the present disclosure can be used in various other combinations, modifications, and environments. In other words, changes or modifications are possible within the scope of the idea of the disclosure disclosed herein, the scope of equivalents to the described disclosure, and/or the scope of skill or knowledge in the art. The implementations describe examples for implementing the technical idea of the present disclosure, and various changes for specific application fields and uses of the present disclosure are possible. Therefore, the detailed description of the present disclosure is not intended to limit the present disclosure to the disclosed implementations. Also, the appended claims should be construed to include other implementations.

What is claimed is:

1. A seat for a vehicle, the seat comprising:
a rear partition assembly disposed adjacent to a rear surface of the seat and configured to be selectively deployed;
a seat cover that defines a rail portion coupled to the rear partition assembly;
a partition driver configured to apply a driving force to the rear partition assembly; and
a controller configured to apply power to the partition driver in response to a user request.

2. The seat of claim 1, wherein the rear partition assembly comprises:
a rear partition configured to be deployed from a rear portion of the seat;
a partition bracket coupled to the rail portion;
a pulley disposed at a rear upper end of the seat;
a wire coupled to the pulley and the partition bracket; and
a drum coupled to the wire via the partition driver.

3. The seat of claim 2, wherein the rear partition is configured to surround at least a portion of the rear portion and a side of the seat.

4. The seat of claim 2, wherein the partition bracket comprises a first protrusion and a second protrusion that is disposed adjacent to the first protrusion, and
wherein the rail portion comprises:
a first rail that receives the first protrusion on the partition bracket; and
a second rail that receives the second protrusion on the partition bracket.

5. The seat of claim 2, further comprising a linear bush disposed at the wire, wherein at least a portion of the linear bush is fixed to the rear partition.

6. The seat of claim 5, further comprising a rear guide portion disposed at opposite sides of the seat cover,
wherein the linear bush is coupled to the partition bracket and configured to move together with the rear partition along the rear guide portion.

7. The seat of claim 4, wherein an upper end of the second rail in a height direction of the seat is located higher than an upper end of the first rail in the height direction.

8. The seat of claim 7, wherein an upper end of the rear partition is configured to deployed in the height direction along the rail portion, and
wherein the second protrusion is configured to, based on the upper end of the rear partition being deployed in the height direction, move along the second rail such that the upper end of the rear partition moves toward a seating surface of the seat.

9. The seat of claim 1, wherein the seat cover further defines an insertion groove configured to receive the rear partition assembly, and
wherein the seat further comprises a partition cover portion configured to cover the insertion groove, the partition cover portion being configured to rotate relative to the seat cover to thereby open the insertion groove.

10. The seat of claim 3, further comprising a side partition assembly disposed adjacent to the rear partition assembly,
wherein the rear partition comprises a fastening portion configured to couple to the side partition assembly.

11. The seat of claim 10, wherein the controller is configured to deploy the rear partition assembly in response to the user request, and
wherein the side partition assembly is configured to insert into the fastening portion based on the rear partition assembly being deployed in response to the user request.

12. The seat of claim 2, wherein the wire is configured to rotate between the pulley and the drum.

13. The seat of claim 10, wherein the fastening portion defines a fastening space between inner sides of the rear partition, and the fastening space narrows as the rear partition extends forward.
